(19) United States
(12) Patent Application Publication
(10) Pub. No.: US 2011/0081633 A1
(43) Pub. Date: Apr. 7, 2011

(54) Game for Promoting Mental Stimulation of Mentally Impaired Individuals

(76) Inventor: Geralyn Jackson-Pearson, Detroit, MI (US)

(21) Appl. No.: 12/571,555

(22) Filed: Oct. 1, 2009

(51) Int. Cl. G09B 19/22

(52) U.S. Cl. 434/129

(57) ABSTRACT

The present invention provides games for promoting mental stimulation of individuals. In one aspect, the game includes random selection of activities to be performed by an individual for causing mental stimulation of the individual. The random activities are particularly designed to cause mental stimulation of individuals having impaired mental faculties. In one embodiment, the present invention provides a game. The game includes a first, second and third set of cards each set having a first indicia and instructions directing a user to perform an activity related to a category of the card set, wherein the categories of each card set are different. The game further includes a die having multiple surfaces, wherein the die includes at least one surface having the first indicia, at least one surface having the second indicia and at least one surface having the third indicia.

### FIELD OF THE INVENTION

The present invention relates to games for promoting mental stimulation of individuals, particularly mentally impaired or disabled individuals.

### BACKGROUND

Many individuals have been or will be affected by different levels of temporary or permanent mental disability due to injury, disease or age related deterioration. Depending on the severity of the disability, such individuals may reside in hospitals, assisted living facilities, homes or otherwise. It has been found that mental stimulation helps to improve cognitive skills and the overall mood of these individuals. However, outside of expensive rehabilitation programs, there has been little done in the development of methods or programs for providing these individuals with structured mental stimulation.

Traditionally, stimulation of mentally impaired individuals comes from nurses, practitioners, care providers, friends or family members engaging these individuals in simple periodic talk. Also, televisions and radios have been used to fill the void of mental stimulation. While these provide some level of periodic mental stimulation, it is not sufficient for the continual development of cognitive skills, mood or overall mental wellbeing of the individual. Further, in settings where an individual is substantially bed ridden, there may be long periods of time between interactions with other people, particularly when visitors are uncertain on ways to provide new types of interaction.

In view of the foregoing, there is a need for improved methods and devices for promoting mental stimulation of individuals, particularly individuals having mental impairment, disability, depression or other mental or mood altering conditions.

### SUMMARY OF THE INVENTION

The present invention provides games for promoting mental stimulation of individuals. In one aspect, the game includes random selection of activities to be performed by an individual for causing mental stimulation of the individual. The random activities are particularly designed to cause mental stimulation of individuals having impaired mental faculties. These activities are divided into categories, each category including a plurality of different activities to be performed.

In one embodiment, the present invention provides a game for mental stimulation of an individual. The game includes a first set of cards each having a first indicia and instructions directing a user to perform an activity related to a first category. The game also includes a second set of cards each having a second indicia and instructions directing a user to perform an activity related to a second category. The game further includes a third set of cards each having a third indicia and instructions directing a user to perform an activity related to a third category. The game further includes a die having multiple surfaces, wherein the die includes at least one surface having the first indicia, at least one surface having the second indicia and at least one surface having the third indicia. The first category, second category and third category are different and include activities configured to promote mental stimulation.

In another embodiment, the present invention provides a method of generating mental stimulation of mentally impaired players of a game. The method includes the steps of: a) rolling a die having multiple surfaces, the die including a single indicia on each surface of the die; b) selecting a card from a set of cards having corresponding indicia to that of one of the surfaces of the rolled die; c) interpreting instructions provided on the selected card; d) performing an activity based upon the instructions provided by the selected card; and e) repeating steps (a) through (d) until a desired level of mental stimulation of a player of the game is reached.

The above-described and other features and advantages of the present invention will be appreciated and understood by those skilled in the art from the following detailed description, drawings, and appended claims.

### BRIEF DESCRIPTION OF THE DRAWINGS

Other objects, features, advantages and details of the present invention appear, by way of example only, in the following detailed description of preferred embodiments of the invention, the detailed description referring to the drawings in which:

FIG. 1 illustrates an exemplary embodiment of a game of the present invention being used by an individual according to the teachings of the present invention;

FIGS. 2A-2C illustrates a first, second and third set of cards according to an exemplary embodiment and teachings of the present invention;

FIG. 3 illustrates a single card according to an exemplary embodiment and teachings of the present invention;

FIG. 4 illustrates an exemplary embodiment of a random selector accordingly to an exemplary embodiment and teachings of the present invention; and

FIG. 5 illustrates a game kit according to an exemplary embodiment of the present invention.

### DESCRIPTION OF THE PREFERRED EMBODIMENTS

It has been found that stimulation of mentally impaired or disabled individuals improve cognitive skills and the overall mood of the individuals. The present invention relates to methods and devices for improving the overall mood and mental condition of individuals, particularly mentally impaired or disabled individuals. More so, the present invention promotes laughter, social communication, healthy ways to improve mood and self-esteem of individuals and can be used for recreational fun or education. Recent research has proven that laughter can have many positive benefits. This is because, at least in part, laughter releases serotonin, a natural ‘feel good’ hormone, while reducing stress hormones. Laughter can also boost the immune system, increase mood and decrease blood pressure as well as attribute to the overall good health of an individual.

The present invention achieves these benefits by providing a game configured to cause and guide interaction between individuals, particularly mentally impaired or disabled individuals, and caregivers such as family, friends, nurses, doctors or otherwise. The present invention guides individuals through the random selection of categories that includes random activities that are enjoyable to the players. In one embodiment, the activities are particularly suited for bringing out the simple joys of life, which most people can relate to, and appreciate, throughout the majority of their life.

In one configuration, the game provides chance with the aforementioned activities. The game may be configured to be presented and controlled by a caregiver or other individual. The game includes a random selector for selecting a category of activities for a user to participate in. Each category provides a different set of activities, each being relatable by most individuals and contemplates different stages and simple enjoyments of life. Through the activity, the achieved mental stimulation improves memory and cognitive skills of the patient. Also, it has been found a particularly useful game for encouraging discussion between individuals, which at times can be challenging after an individual has undergone some level of mental disability or impairment. The game may be played until a desired level of mental stimulation is achieved, such as the beginning of mental fatigue of one or more players, a predetermine time period, until interest in the game by one or more of the players begin to wane or otherwise.

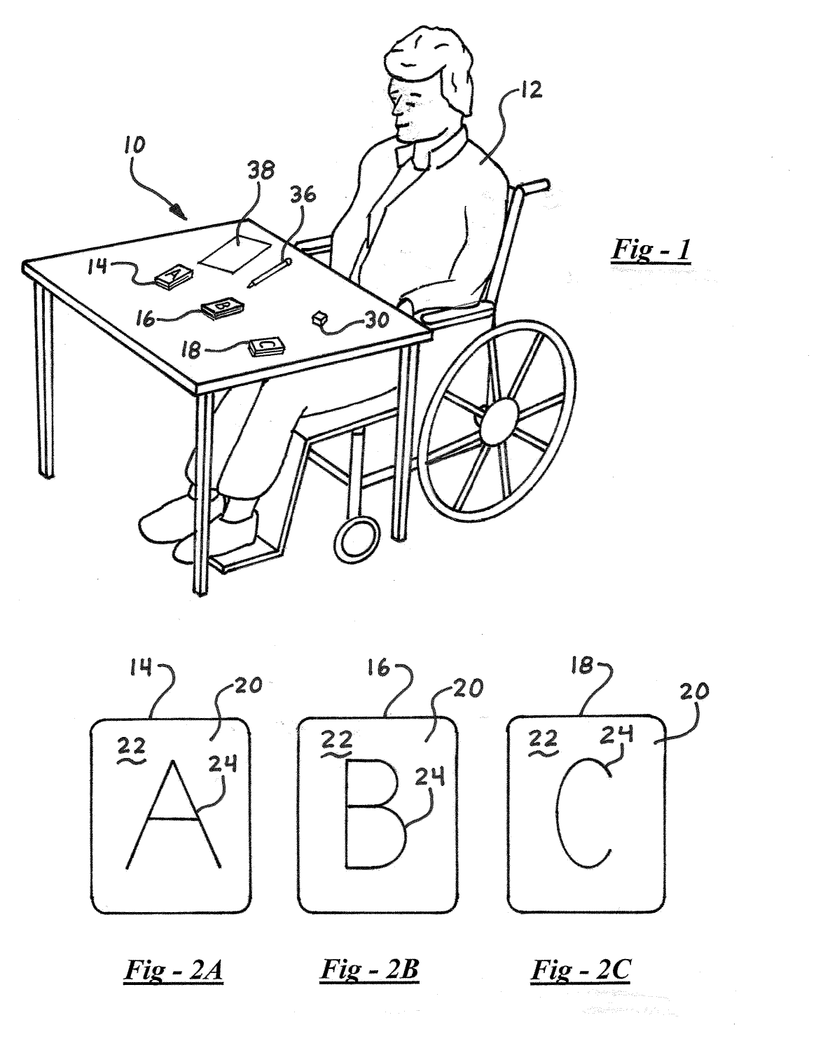

In view of the foregoing, referring to FIG. 1, a first embodiment of a game 10 of the present invention is shown. The game is configured for use with one or more individuals 12 and particularly suited for use with a first individual, such as a caregiver, family, friends or otherwise, and one or more, or even a group, of other individuals 12, which may have some level of mental impairment or disability. Accordingly, it should be appreciated that the game may be used on a one-on-one basis or in a group setting. For example, it is contemplated that a caregiver or otherwise may participate with 1, 2, 3, 4, 5, 6 or more disabled individuals in playing the game 10. Also, depending on the level of mental impairment or disability, it is contemplated that two or more disabled individuals may play the game together, i.e. without a caregiver or otherwise. Other configurations are possible.

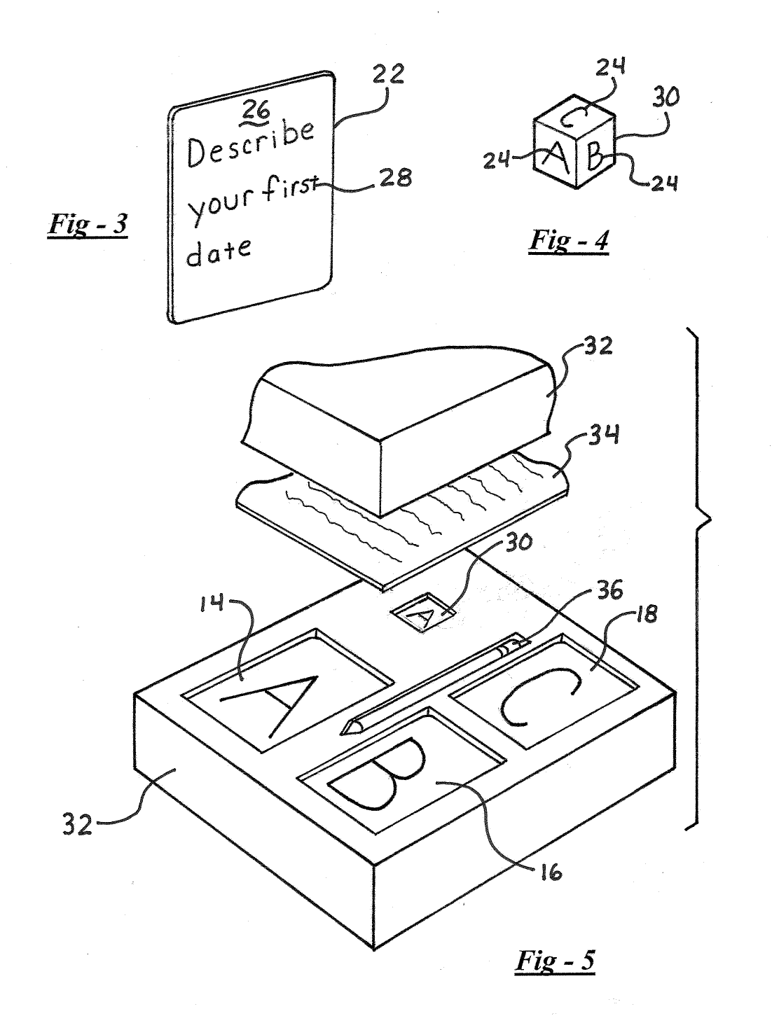

The game may include one, or a plurality, set of cards having a first side including an indicia and a second side including instructions corresponding to an activity. In one embodiment, referring to FIGS. 2A-3, the game 10 includes a first set of cards 14, a second set of cards 16 and a third set of cards 18. Each of the first, second and third set of cards 14, 16, 18 include a plurality of cards 20 having a first side 22 including a distinct indicia 24 and a second side 26 including instructions 28. In one exemplary embodiment, the instructions 28 correspond to an activity. The game further includes a random selector, such as die 30, for randomly selecting the first, second or third set of cards 14, 16, 18. The die includes a plurality of surfaces 32 including indicia 24 corresponding to the indicia 24 located on the first, second and third set of cards, 14, 16, 18. Each of the first, second and third set of cards include an indicia forming a distinctive mark to distinguish between the sets of cards, which corresponds to at least one distinct indicia disposed on a surface of the die. The game is played by rolling the die 30 to randomly select an indicia. A card is selected from the set of cards having a corresponding indicia to the die 30 and an activity is performed according to the instructions of the selected card.

The first, second and third set of cards 14, 16, 18 include activities corresponding to a particular category. The category of the first, second third set of cards may be similar or dissimilar. However, in one exemplary embodiment, the categories of the first, second and third set of cards a different, which provides for a broader spectrum of activities that may be performed, via the instructions 28 located on the individual cards 20.

The number of cards 20 per set may include any suitable number of cards. In one exemplary embodiment, the game 10 include a sufficient number of cards to keep the game play fresh. For example, the game may include 15, 30, 45, 60 or more cards, each having different instructions. Further, it is contemplated that each set of cards may include 5, 10, 20 or more cards, each having different instructions. It should be appreciated that additional cards may be purchased for use with the game 10 of the present invention.

The categories of the sets of cards may include any suitable category for directing users to perform a task. In one exemplary embodiment, the categories are particularly suited to cause enjoyment for participants of the game, such as recollecting on past enjoyable experiences, performing a fun or silly acts, performing an enjoyable task configured to cause cognitive development or otherwise. Examples of suitable categories include, but are not limited to: performing verbal communicative acts, performing physical acts, contemplating past experiences, combinations thereof or otherwise.

In one exemplary embodiment, a set of cards is indicated as ‘Laughing Matters’. In this embodiment, the set of cards includes a category with instructions directing a particular player to participate in humorous or laughing activities. In doing so, the set of cards directs an individual to share with one or more other players a past experience or memory which the player perceives as particularly funny, as it relates to the particular instructions. For example, the cards of the set provides instructions to recite a past experience or memory, experience by the player or otherwise, related to: babysitting, Bar-B-Que, holiday, birthday, work, pet, trip or vacation, children, water, favorite comedy sitcom, favorite comedian, date, childhood, family event, shopping, friends, surprise, school, parents, fishing trip or otherwise. Upon selection of the card, the player recites a past humorous experience as it relates to the particular instruction topic, as described above. The other players share in the enjoyment by listening to the story and contemplating their own experiences.

In another exemplary embodiment, a set of cards is indicated as ‘Sunny Side Up’. In this embodiment, the set of cards includes a category with instructions directing a player to participate, either alone or with another player, in an activity that tends to brighten ones' spirits. For example, the cards may instruct a player to participate in an activity, such as: go for a walk; listen to music; go to the park; go to the zoo; call a friend; watch a comedy movie; watch a sitcom; go to a comedy show; eat a favorite dessert; invite friends over; reminisce; sit by the water (e.g., beach, lake, pond, pool or even a puddle); go fishing; play in the snow; play in the rain; jump in a pile of leaves; explore a creative side (e.g., draw, paint, sing, dance, color, write or otherwise); laugh; walk barefoot in the grass; live life to the fullest; or otherwise. Upon selection of the card, the player participates, either immediately or in the future, the activity corresponding to the instructions of the selected card.

In another exemplary embodiment, a set of cards is indicated as ‘Clowning Around’. In this embodiment, the set of cards includes a category with instructions directed towards participating in an activity oriented to make the individual or another individual laugh or otherwise find some sort of humor in the conduct. For example, the cards of the set may provide instructions for an individual to: draw a funny face; make a funny face; make a funny noise; wiggle your ears; wiggle you nose; cross your eyes; draw yourself with your eyes closed; write your name backwards; repeat five times “she saw Sally see-saw”; touch your nose with your tongue; teach the group a dance; sing your favorite song; play patty cake with the person on your left; give a smile to the person on your right; give a smile to the 2^{nd} person on your left; talk in a funny voice; laugh; demonstrate how you would make a baby smile; thumb wrestle the person across from you; repeat five times “Billy Blue breaks big bricks”; or otherwise. Upon selection of the card, the player participates in the activity corresponding to the instructions of the selected card. Again, the other players share in the enjoyment by observing the humorous conduct and contemplating their own conduct.

It should be appreciated that the instructions described herein may direct a player to participate in the activity at the present time or at a time in the future. While three examples of different categories of instructions have been given, it should be appreciated that more or less categories may be provided for maintaining stimulation and interest in the game. For example, it is contemplated that there may be 1, 2, 3, 4, 5, 6, or more categories of cards or instructions, wherein each category represents a different set of activities or instructions.

As previously mentioned, referring to FIGS. 2A-4, the cards 20 and die 30 includes indicia for providing the ability to select a category or set of cards through a random selection. The indicia may comprise any suitable indicia for separating and categorizing the cards. For example, the indicia may include numbers, letters, words, pictures, symbols or otherwise. In one exemplary embodiment, the indicia comprises colors, such as red, blue, green, orange, purple, yellow, black, white or otherwise for distinguishing the cards. In another exemplary embodiment, the indicia comprises pictures corresponding to the category of activities, such as a person laughing for ‘Laughing Matters’, a sun for ‘Sunny Side Up’, and a clown for ‘Clowning Around’. Other configurations are possible. Accordingly, it is contemplated that the die 30 includes multiple surfaces for representing each of the unique indicia. It should be appreciated that the number of indicia may correspond to the number of sets of cards and/or number of sides in the die 30. It is contemplated that the game may include six different indicia and sets of cards, one per side of the die 30. However, the die may include multiple sides with the same indicia and the die may include more or less than six sides. For example, in one embodiment the die 30 includes six sides representing three different indicia, twice.

Further, it should be appreciated that other random selectors may also be used having any number of indicia. Other random selectors may include electronic random category selectors, mechanical random selectors such as spin wheels, or otherwise. Similarly, the categories and activities need not be placed on cards, but instead on other means including, but not limited to, lists, three-dimensional objects or otherwise.

In one exemplary embodiment, the game of the present invention further includes instructions for assisting players through the play of the game. The instructions include performing a warm-up activity to get the participants of a game interested and increase the overall awareness of players. This may involve any number of acts for getting the attention of an individual or group, such as getting the players to laugh or otherwise. For example, the warm-up activity may comprise the following act by a leader (e.g., caregiver or otherwise) of the game:
Stand at the door as clients arrive and ask them to show you their elbow (you are looking for their funny bone). They will look at you in a strange way, but that's ok it's all part of setting the mood. As you look at their elbow you say, “I just had to make sure you had it”. Once everyone is in you tell them that you were checking for funny bones and explain the activity.
   The warm up activity can include any activity to gain the attention of an individual or group. In one exemplary embodiment, the warm-up activity is directed towards individuals who are mentally impaired or disabled.

In another exemplary embodiment, the warm-up activity comprises describing or encouraging players to recited a funny thing that happened to them or describe a collection of mishaps people commonly encounter. For example, the warm-up activity may comprise the following act by the leader of the game:
1. Talk about embarrassing situations. For examples, as I walked across my college campus my wrap skirt came undone the only thing that kept it from falling completely off was my backpack.
2. During the course of potty training my son decided to show off his new skill. He made poop in the potty, the only problem is that we were in a store and it was the one off the shelf. I didn't know if I should clap or run and hide.
3. Ever lost your swim suit while swimming?
4. Once I was really nervous during a speech and all I could do was hiccup.
   It should be appreciated that the warm-up activity may comprise other activities configured to grab the attention of the participant of the game. Further, it should be appreciated that the warm-up activities may be used as a wrap-up activity for ending the session of game playing.

In one exemplary embodiment, the instructions further direct a participant to stack the cards 20 pursuant to their set, e.g., indicia, 14, 16, 18. A first player is selected and rolls the die 30 to select one of the set of cards having a category. The first player then selects a card of the card set and performs an activity indicated by the selected card. Upon completion, another player rolls the die and the game is continued until a desired level of mental stimulation is reached.

Referring to FIG. 5, in one exemplary embodiment, a kit is provided including the components of the game. The kit includes a container, such as box 32, configured to receive and store the first, second and third set or cards, 14, 16, 18. The box 32 is further configured to receive and store other items of the game including die 30, instruction sheet 34, pencil or pen 36, writing paper 38 or otherwise. It should be appreciated that the kit may be offered for sale as a complete game 10. Also, additional cards may be made available for purchase.

While the invention has been described with reference to a preferred embodiment it will be understood by those skilled in the art that various changes may be made and equivalents may be substituted for elements thereof without departing from the scope of the invention. Accordingly, such embodiments further include rails, gates or other barriers. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A game for providing mental stimulation for one or more individuals, comprising:
a first set of cards each having a first indicia, each of the first set of cards include instructions directing a user to perform an activity related to a first category;
a second set of cards having a second indicia, each of the second set of cards include instructions directing a user to perform an activity related to a second category;
a third set of cards having a third indicia, each of the third set of cards includes instructions directing a user to perform an activity related to a third category; and
a die having multiple surfaces, wherein the die includes at least one surface having the first indicia, at least one surface having the second indicia and at least one surface having the third indicia,
wherein the first category, second category and third category are different and includes activities configured to promote mental stimulation.

2. The game of claim 1, wherein the first category provides instructions for a user to recite a past pleasurable experience, wherein the second category provides instructions for a user to participate in a pleasurable activity, and wherein the third category provides instructions for a user to perform an act which they perceive as amusing.

3. The game of claim 2, wherein the first indicia comprises a first color, the second indicia comprises a second color and the third indicia comprises a third color, the first, second and third colors being different.

4. The game of claim 3, wherein each side of the die includes a surface having at least one indicia.

5. The game of claim 4, further comprising instructions for directing users on how to play the game, and wherein the instructions direct a user to guide at least one mentally impaired person through the play of the game.

6. The game of claim 5, wherein each of the first, second and third set of cards includes at least 10 different instructions.

7. The game of claim 6, wherein all of the instructions of the first, second and third set of cards are different.

8. The game of claim 7, wherein the first set of cards, second set of cards, third set of cards, die and instructions are provided together as a kit.

9. A method of generating mental stimulation of mentally impaired players of a game, comprising the steps of:
a) rolling a die having multiple surfaces, the die including a single indicia on each surface of the die;
b) selecting a card from a set of cards having corresponding indicia to that of one of the surfaces of the rolled die;
c) interpreting instructions provided on the selected card;
d) performing an activity based upon the instructions provided by the selected card; and
e) repeating steps (a) through (d) until a desired level of mental stimulation of a player of the game is reached.

10. The method of claim 9, wherein steps (a) through (e) are performed by a single individual.

11. The method of claim 9, wherein steps (a) through (e) are repeated by multiple individuals.

12. The method of claim 9, further comprising the step of interacting with players of the game prior to step (a) to promote awareness and interest in the game.

13. The method of claim 12, wherein the steps (a) through (e) are provided on instructions provided with the set of cards and die.

14. The method of claim 13, wherein the die includes multiple surfaces, each surface including different indicium.

15. The method of claim 14, wherein multiple sets of cards are provided, each set of cards including an indicia corresponding to a surface of the die and instructions corresponding to the activity to be performed, and wherein each set of cards include a different category of instructions.

16. The method of claim 15, wherein three sets of cards are provided, each set of cards including a different category of instructions.

17. The method of claim 16, wherein a first set of cards includes instructions for describing a past pleasurable experience by a player of the game, wherein a second set of cards includes instructions for participation in a pleasurable activity by a player of the game, wherein a third set of cards includes instructions for performing an amusing act by a player of the game.

18. The method of claim 9, wherein the activity performed comprises verbal description of a past pleasurable experience by a player of the game as indicated by the selected card.

19. The method of claim 9, wherein the activity performed comprises participation in a pleasurable activity by a player of the game as indicated by the selected card.

20. The method of claim 9, wherein the activity performed comprises performing an amusing act by a player of the game as indicated by the selected card.
